(19) United States
(12) Patent Application Publication
(10) Pub. No.: US 2005/0053727 A1
(43) Pub. Date: Mar. 10, 2005

(54) Use of a coating composition for producing a temporary protective coat on plastics surfaces

(75) Inventors: Michael Schlipf, Goppingen-Bartenbach (DE); Georg Burkhardt, Remshalden (DE); Uwe Hilsenbek, Urbach (DE)

Correspondence Address: BURNS DOANE SWECKER & MATHIS L L P, POST OFFICE BOX 1404, ALEXANDRIA, VA, 22313-1404, US

(73) Assignee: ZellerGmbH & Co. KG

(21) Appl. No.: 10/853,680

(22) Filed: May 26, 2004

Related U.S. Application Data
(63) Continuation of application No. PCT/EP02/13400, filed on Nov. 27, 2002.

(30) Foreign Application Priority Data
Nov. 27, 2001 (DE) 101 58 118.1

(51) Int. Cl. B05D 1/18

(52) U.S. Cl. 427/421.1; 427/428.01; 427/430.1; 427/429

(57) ABSTRACT

A method is disclosed for producing a temporary protective coat against soiling and electrostatic charging on a plastic surface. The method includes applying a coating composition, based on the weight of the coating composition: up to 20% of a coat-forming component, 0 to 20% of an additive, 0 to 20% of a solubilizer, the remainder to 100% consisting of water and/or one or more water-soluble solvents, the solvent or solvents being present in an amount of 0 to 30%.

### CROSS REFERENCE TO RELATED APPLICATIONS

This application claims priority under 35 U.S.C. §119 to German Application 101 58 118.1 filed in Germany on 27 Nov. 2001, and as a continuation application under 35 U.S.C. §120 to PCT/EP02/13400 filed as an International Application on 27 Nov. 2002 designating the U.S., the entire contents of which are hereby incorporated by reference in their entireties.

### BACKGROUND

Plastics have a high electrical resistance. Polycarbonates in particular, therefore, become electrostatically charged in the course of transport, processing and storage.

As a result of this charging, particles of dirt, for example, are attracted from the surroundings of the plastic and deposit on the surface.

The layer of dirt formed as a result of this can be removed only by the action of mechanical forces or with the aid of special organic solvents.

Particularly in the case of surface-treating processing operations, such as painting, coating, adhesive bonding and so on, electrostatically deposited layers of this kind are disturbing.

In the past, therefore, attempts have been made to prevent the charging and hence the soiling by the application of antistats. In the downstream surface-treatment operations, however, these antistats are disturbing and must therefore be removed before further processing.

In order to effect such removal, prior to painting, for example, the plastics parts are cleaned in wash units. These wash units possess two or more treatment zones: one frequently used arrangement, for example, is composed of a wash bath and three rinse baths. In many cases the wash bath contains not just water but also surface-active substances (surfactants). There are acidic, neutral or alkaline baths, which offer advantages depending on the type of plastic.

The surfactants used for cleaning are generally non-ionic, anionic or amphoteric surfactants. Since, however, in those specific applications known to the applicant, the antistatic treatment takes place with cationic surfactants, there may be interactions in the wash bath of the wash unit and, consequently, there may be disturbances in the operation.

### SUMMARY

Methods are disclosed for preventing the surface soiling of plastics without thereby entailing disturbances affecting subsequent treatment techniques. In addition, the aggressive mechanical or chemical cleaning methods which are necessary in the state of the art for surfaces which have already been soiled can be avoided.

This also applies to the temporary protective coatings for plastics surfaces that are described in WO 00/01773, for which the coat-forming component employed comprises special electrically conductive polymers, such as, in particular, special electrically conductive polyheterocycles. Further polymers with an antistatic effect are known from EP-A-0 012 513, EP-A-0 560 854 and EP-A-0 822 236. The antistatic substances described therein, however, are used not for temporary protective coverings but rather for permanent coatings.

GB-B 578,540 discloses solid polyethylene glycol compositions within which the polyethylene glycol is intended to exert a protective function for the tartaric acid and sodium hydrogen carbonate that are additional components of the composition, and is intended to prevent unwanted premature reaction of these components. For that purpose the tartaric acid is dissolved in melted polyethylene glycol and the cooled solution is mixed with the required amount of sodium bicarbonate. The polyethylene glycol specified for use therein is one having a molecular weight of at least 4000. GB-B 632,594, finally, discloses the use of polyvinyl acetate as a component of a temporary coating.

Surprisingly it has now been found that when the coating composition described in more detail below is used for producing a temporary protective coat on the plastics surfaces in question, the soiling of these surfaces is virtually prevented if this composition is applied immediately after the shaping of the plastics parts.

### DETAILED DESCRIPTION

A method is disclosed for producing a temporary protective coat against soiling and electrostatic charging on plastics surfaces in accordance with aspects 1.) to 11.) below:

A method is disclosed for producing a temporary protective coat against soiling and electrostatic charging on a plastic surface, the method comprising applying to the plastic surface, a coating composition comprising, based on the weight of the coating composition:
up to 20% of a coat-forming component,
0 to 20% of an additive,
0 to 20% of a solubilizer,
the remainder to 100% consisting of water and/or one or more water-soluble solvents, the solvent or solvents being present in an amount of 0 to 30%.

Method according to aspect 1, wherein the coat-forming component is polyvinyl alcohol, poly-ethylene glycol, water-soluble polyvinyl acetate, a polysaccharide, a polyglycol ether, a polycarboxylate, polyacrylic acid, cellulose or a maleic acid/acrylic acid copolymer, maleic acid/olefin copolymer or maleic acid/methyl vinyl ether copolymer.

Method according to aspect 1 or 2, wherein the coat-forming component possesses a molar mass of 300 to 250 000, preferably from 4000 to 6000 g/mol.

Method according to one or more of the preceding aspects, wherein the additive is an anionic, nonionic or amphoteric surfactant.

Method according to one or more of the preceding aspects, wherein the surfactant is a low-foaming surfactant.

Method according to one or more of the preceding aspects, wherein a coat-forming surfactant having a molar mass of 300 to 100 000 g/mol, preferably 300 to 1000 g/mol, most preferably 400 to 1000 g/mol, is used. A suitable molar mass is 500 to 1000 g/mol.

Method according to one of aspects 1 to 6, wherein as coat-forming component exclusively a coat-forming surfactant, in particular a coat-forming surfactant having a molar mass of 300 to 100 000 g/mol, preferably 400 to 1000 g/mol, is used.

Method according to one or more of the preceding aspects, wherein the plastics surface is of polycarbonate, polyethylene, polypropylene, polyvinyl chloride, ABS, polyacrylate, polyurethane, epoxy resin, synthetic resin, polyester, melamine resin, ABS, TPU, TPE alone and as a mixture with copolymers such as e.g. PC/PBT, PC/PET, PP/EPDM.

Method according to one or more of the preceding aspects, wherein in the coating composition the remainder to 100% is exclusively water.

Method according to one or more of aspects 1 to 8, wherein the water-soluble solvent is ethanol or isopropanol.

Method according to one or more of the preceding aspects, wherein the coating composition, optionally following dilution with water, is applied to the plastics surface by spraying, dipping, brushing, rolling or pouring and is subsequently dried to form a protective coat, this protective coat being removed again prior to further processing of the plastics surface in a customary wash process with downstream rinse baths.

Specifically an exemplary coating composition can possess the following constitution.
Suitable coat-forming components include coat-forming polymers, such as polyvinyl alcohol, polyethylene glycol, water-soluble polyvinyl acetate, polysaccharides, polyglycol ethers, polycarboxylates, polyacrylic acid, cellulose, or maleic acid/acrylic acid, maleic acid/olefin or maleic acid/methyl vinyl ether copolymers. Use is made in particular of polyvinyl alcohol, poly-ethylene glycol, polyglycol ethers and polycar-boxylates. The coat-forming components preferably possess a molar mass of 300 to 250 000 g/mol, in particular of 4000 to 6000 g/mol. These substances are particularly suitable when they have low to medium degrees of polymerization. Preference is given to using those polymers for which at a water temperature of 20° C. the polymer still has a water solubility of at least 5%, in particular >10%. Also suitable as coat-forming component, for example, are the coat-forming surfactants specified below. These may make it unnecessary to use the coat-forming polymers described above.
Basis: The coating composition is prepared on an aqueous basis. Preferably the basis is composed exclusively of water. If desired, however, fractions of water-soluble solvents, such as ethanol and isopropanol, may be present. The water-soluble solvents are present at 0-50% by weight, preferably 0-20%. Further water-soluble solvents are: methanol, butyl glycol, butyl diglycol, methyl glycol, methyl diglycol, ethylene glycol, and so on.
Optional components: In order to assist subsequent cleaning of the substrate surface, in the wash unit for example, it is possible for surface-active or cleaning or cleaning-assisting components, such as wetting agents, to be present as an additive. Suitable wetting agents include anionic, nonionic and amphoteric surfactants. These are the usual surfactants known to the person skilled in the art. Use is made in particular of low-foaming surfactants. The surfactants in question can, in particular, be those which do not foam at temperatures of above 40° C. Preferably the surfactants possess a molar mass of 300 to 100 000 g/mol, in particular 400 to 1000 g/mol. In one preferred embodiment, surfactants are used which are capable of forming a coat. Surfactants of this kind possess in particular the aforementioned molar mass of from 300 to 100 000 g/mol, with particular preference from 400 to 1000 g/mol. An example of such a surfactant are fatty alcohol ethoxylate propoxylates, e.g. C₁₀/C₁₂ fatty alcohol 5 EO, 4 PO. In the case of such surfactants with a coat-forming effect it is possible, as stated, for the use of an independent coat-forming component to be omitted. Further optional additives which can be used include the following: colorants, preservatives, odour enhancers, thixotropic agents, gel formers. If desired a solubilizer, such as sodium cumenesulphonate, for example, can be used. Further suitable solubilizers are all hydrotropic compounds, e.g. xylenesulphonates, short-chain alkyl sulphates, urea, sodium butyl monoglycol sulphate, and so on.
Proportions: The coat-forming component is generally present in an amount of up to 20% by weight, preferably in an amount of 5 to 10% by weight, based on the weight of the coating composition. The additives present where appropriate are present preferably in an amount of up to 20% by weight, in particular from 5 to 10% by weight, based on the coating composition. Any solubilizer is present preferably in an amount of up to 20% by weight, in particular 5 to 15% by weight, based on the weight of the coating composition. The proportions of the coating composition that remain to make up 100% by weight are composed of water alone or of water and one or more water-soluble solvents, such as ethanol or isopropanol. The water-soluble solvents in this case are present generally in an amount of 0-30% by weight, in particular 5 to 20% by weight.

The coating composition used can be prepared in conventional manner by combining and homogenizing the components.

The coating composition used can be particularly suitable for producing a protective coat on products produced from materials which are readily electrostatically chargeable (e.g. in the case of insulators) or products which have been provided with electrostatically chargeable coatings. Such products or substrate surfaces are in particular those of poly-carbonates, polyethylene, polypropylene, ABS, polyacrylate, polyurethane, epoxy resin, synthetic resin, polyester, melamine resin, ABS, TPU, TPE alone and as a mixture with copolymers such as PC/PBT, PC/PET, PP/EPDM, for example.

The coating composition used can be advantageously applied immediately after the shaping or production of the substrate, by injection moulding, for example. In general the coating formulation described is applied in dilute form, generally in 5 to 50%, preferably 5 to 20%, in particular about 10% aqueous dilution, to the parts that are to be coated. Alternatively the dilution can also be made with a mixture of water and the aforementioned water-soluble solvent, such as ethanol, isopropanol, methanol, butyl glycol, butyl diglycol, methyl glycol, methyl diglycol and ethylene glycol, particularly in the above proportions. Application to the parts that are to be coated takes place in general by spraying onto the surface until it is fully wetted. Instead of the spraying process it is possible to employ any other suitable application process, such as dipping, brushing, rolling or pouring. Subsequent drying can take place by simple storage at room temperature. Also possible is forced drying, in a thermal dryer for example, preferably with circulating air, at temperatures up to 80° C. Alternatively, the drying can also take place with the aid of infrared. The coat thickness after the drying is preferably about 2 to 10 μm.

The protective coating obtained in this way is resistant to not-too-vigorous mechanical influences and to water for a short exposure time at room temperature.

The removal of the protective coat is necessary in particular prior to further processing of the surface, such as prior to painting, electroplating or currentless deposition, or before adhesive bonding operations. The coating can be removed with water and/or solvents. The exposure time necessary for this to occur depends on the temperature conditions. Removal can take place at room temperature or else at temperatures above 40° C., the exposure time being shortened in the last-mentioned case. Suitable for removal are the customary known wash methods, dipping, ultrasound, spraying, for example a wash method in what are called “power wash” units. In this case the protective coat is removed in a wash bath and the surface is rinsed free from residues in downstream rinse baths.

In the context of exemplary embodiments of the invention, preferably the wash operation is carried out in wash liquors which are neutral or slightly to strongly alkaline and which may comprise anionic surfactants. In such a case, cationic surfactants would disturb the wash operation. For this reason preference is given to employing hydrophilic coating compositions which contain no cationic surfactants.

In accordance with exemplary embodiments of the invention it is therefore possible, by using the coating composition described, to obtain effective surface protection against soiling and electrostatic charging on plastics parts and thereby to avoid the problems of the prior art which result from the soiling which has already occurred.

The examples which follow illustrate embodiments of the invention without restricting it.

### EXAMPLE 1

### Coating Formulation

The following coating formulation was prepared by combining and homogenizing the following components in a manner known per se:
5% by weight PEG; molecular weight: 4000
5% by weight polyethylene glycol ether (7 EO)
10% by weight sodium cumenesulphonate
80% by weight water

### EXAMPLE 2

### Coating Formulation

The following coating formulation was prepared by combining and homogenizing the following components in a manner known per se:
15% by weight fatty alcohol ethoxylate propoxylate (C₁₀/C₁₂ fatty alcohol 5 EO, 4 PO)
4% by weight sodium cumenesulphonate
81% by weight water

With this composition the surfactant, in addition to its surface-active effect, at the same time also takes on the function of coat-forming component.

### EXAMPLE 3

### Use Example

The coating formulation of Example 1 in 10% dilution with water is applied by spraying to the plastics parts that are to be coated (made of polycarbonate-polybutylene terephthalate copolymer) immediately following their removal from the injection mould, until the surface is fully wetted. Drying follows, by simple storage at room temperature or under forced conditions in a thermal dryer.

The coating obtained is stable to not-too-vigorous mechanical effects and also to water when exposed for a short time and under room temperature conditions. It can be removed without problems by means of a customary wash process in conjunction with downstream rinse baths.

An equivalent result can be achieved with the composition from Example 2 as well.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. Method for producing a temporary protective coat against soiling and electrostatic charging on a plastic surface, comprising:
applying, to the plastic surface, a coating composition comprising, based on the weight of the coating composition:
up to 20% of a coat-forming component;
0 to 20% of an additive;
0 to 20% of a solubilizer; and,
the remainder to 100% consisting of water and/or one or more water-soluble solvents, the solvent or solvents being present in an amount of 0 to 30%.

2. Method according to claim 1, wherein the coat-forming component is polyvinyl alcohol, poly-ethylene glycol, water-soluble polyvinyl acetate, a polysaccharide, a polyglycol ether, a polycar-boxylate, polyacrylic acid, cellulose or a maleic acid/acrylic acid copolymer, maleic acid/olefin copolymer or maleic acid/methyl vinyl ether copolymer.

3. Method according to claim 1, wherein the coat-forming component possesses a molar mass of 300 to 250 000 g/mol is used.

4. Method according to claim 1, wherein the additive is an anionic, nonionic or amphoteric surfactant.

5. Method according to claim 1, wherein the surfactant is a low-foaming surfactant.

6. Method according to claim 1, wherein a coat-forming surfactant having a molar mass of 300 to 100 000 g/mol is used.

7. Method according to claim 6, wherein as a coat-forming component exclusively a coat-forming surfactant having a molar mass of 300 to 100 000 g/mol is used.

8. Method according to claim 1, wherein the plastic surface is of polycarbonate, polyethylene, polypropylene, polyvinyl chloride, ABS, polyacrylate, polyurethane, epoxy resin, synthetic resin, polyester, melamine resin, ABS, TPU, TPE alone and as a mixture with copolymers.

9. Method according to claim 1, wherein in the coating composition the remainder to 100% is exclusively water.

10. Method according to claim 1, wherein the water-soluble solvent is ethanol or isopropanol.

11. Method according to claim 1, wherein the coating composition, optionally following dilution with water, is applied to the plastic surface by spraying, dipping, brushing, rolling or pouring and is subsequently dried to form a protective coat, this protective coat being removed again prior to further processing of the plastic surface in a wash process with downstream rinse baths.

12. Method according to claim 2, wherein the coat-forming component possesses a molar mass of 300 to 250 000 g/mol.

13. Method according to claim 1, wherein the coat-forming component possesses a molar mass of 4000 to 6000 g/mol.

14. Method according to claim 12, wherein the additive is an anionic, nonionic or amphoteric surfactant.

15. Method according to claim 14, wherein the surfactant is a low-foaming surfactant.

16. Method according to claim 15, wherein a coat-forming surfactant having a molar mass of 300 to 100 000 g/mol is used.

17. Method according to claim 1, wherein a coat-forming surfactant having a molar mass of 400 to 1000 g/mol is used.

18. Method according to claim 16, wherein as a coat-forming component exclusively a coat-forming surfactant having a molar mass of 300 to 100 000 g/mol is used.

19. Method according to claim 6, wherein as a coat-forming component exclusively a coat-forming surfactant having a molar mass of 400 to 1000 g/mol is used.

20. Method according to claim 18, wherein the plastic surface is of polycarbonate, polyethylene, polypropylene, polyvinyl chloride, ABS, polyacrylate, polyurethane, epoxy resin, synthetic resin, polyester, melamine resin, ABS, TPU, TPE alone and as a mixture with copolymers.

21. Method according to claim 20, wherein in the coating composition the remainder to 100% is exclusively water.

22. Method according to claim 20, wherein the water-soluble solvent is ethanol or isopropanol.

23. Method according to claim 20, wherein the coating composition, optionally following dilution with water, is applied to the plastic surface by spraying, dipping, brushing, rolling or pouring and is subsequently dried to form a protective coat, this protective coat being removed again prior to further processing of the plastic surface in a wash process with downstream rinse baths.

24. Method according to claim 8, wherein the copolymers are PC/PBT, PC/PET, or PP/EPDM.
